(19) United States
(12) Patent Application Publication
(10) Pub. No.: US 2011/0247977 A1
(43) Pub. Date: Oct. 13, 2011

(54) Device for Treating Wastewater Comprising Nitrogen and Phosphorus and a Method for the Same

(75) Inventors: Kyung Guen Song, Nowon-gu (KR); Kyu Hong Ahn, Gangnam-gu (KR); Kang Woo Cho, Gwanak-gu (KR); Jin Woo Cho, Gangnam-gu (KR); Hae Seok Oh, Bucheon-si (KR); Dong Won Ki, Seodaemun-gu (KR)

(73) Assignee: KOREA INSTITUTE OF SCIENCE AND TECHNOLOGY, Seongbuk-gu (KR)

(21) Appl. No.: 12/834,576

(22) Filed: Jul. 12, 2010

(30) Foreign Application Priority Data
Apr. 7, 2010 (KR) 10-2010-0031890

(51) Int. Cl. C02F 3/32; B01D 35/00

(52) U.S. Cl. 210/602; 210/205; 210/151

(57) ABSTRACT

Disclosed are a device for treating nitrogen and phosphorus from wastewater, including: an algal culture tank for culturing microalgae capable of treating nitrogen and phosphorus from wastewater; and a separation membrane for separating thus treated water from the microalgae, and a method for the same.

According to the disclosed device and method, microalgae are cultured at high concentrations using wastewater, instead of an artificial culture medium, as a culture medium. As a result, nitrogen and phosphorus can be effectively treated from the wastewater, and the microalgae, which are useful as a biomass, may be cultured and recovered stably.

### CROSS-REFERENCE TO RELATED APPLICATION

This application claims priority to Korean Patent Application No. 10-2010-0031890, filed on 2010.04.07, and all the benefits accruing therefrom under 35 U.S.C. §119, the contents of which in its entirety are herein incorporated by reference.

### BACKGROUND

1. Field

This disclosure relates to a device and a method for treating nitrogen and phosphorus from wastewater, more particularly to a device and a method for treating nitrogen and phosphorus from wastewater whereby microalgae capable of treating nitrogen and phosphorus from wastewater are continuously cultured at high concentrations without the need of supplying an artificial culture medium.

2. Description of the Related Art

Recently, with regard to the problem of global warming caused by carbon dioxide emission and the efforts to reduce carbon dioxide emission globally, microalgae are gaining a lot of attentions.

Since microalgae can fix carbon dioxide biologically and may be used to produce biomass, which may be used as animal or fish feed, biodiesel or source material for biorefinery, they are viewed as a next-generation energy source. If nitrogen and phosphorus needed to culture the microalgae can be supplied from wastewater, it may also serve the purpose of treating the wastewater.

Thus, attempts have been made recently to culture microalgae using wastewater as a culture medium such as the development of a microalgal culture medium using livestock wastewater (Korean Patent Publication Nos. 2003-0076133 and 2003-0095154). However, because they aim at cultivation of algae, they do not provide stable treatment of wastewater.

As techniques for treating wastewater using microalgae, a device and a method for water purification using a movable floating contact media module and an algae module (Korean Patent Publication No. 2006-0100869) and a method for improving water quality of rural communities using a periphytic algal system (Korean Patent Publication No. 2005-0024728) are disclosed.

However, these techniques are restricted in that the water a river, lake, marsh, sewage treatment facility, or the like has to be used as it is, the treatment efficiency of nitrogen and phosphorus is low because algal growth cannot be controlled artificially, and it is very difficult to control the treatment efficiency. Further, the use of periphytic algae or algae existing in given systems makes it difficult to stably produce and recover the microalgae which may be used as sources of feed or other useful materials such as biodiesel.

### SUMMARY

In order to overcome the disadvantages of the existing wastewater treatment techniques, this disclosure is directed to providing a device and a method capable of improving the efficiency of treating nitrogen and phosphorus from wastewater by culturing microalgae using the wastewater as a culture medium instead of the existing artificial culture medium and, at the same time, stably culturing and recovering microalgae which may also be used as sources of animal or fish feed, biodiesel or source material for biorefinery.

In one general aspect, there is provided a device for treating nitrogen and phosphorus from wastewater, including: an algal culture tank for culturing microalgae capable of treating nitrogen and phosphorus from wastewater; and a separation membrane for separating the water with nitrogen and phosphorus treated by the cultured microalgae from the microalgae.

In another general aspect, there is provided a method for treating nitrogen and phosphorus from wastewater, including: culturing microalgae capable of treating nitrogen and phosphorus from wastewater in an algal culture tank; and separating the water with nitrogen and phosphorus treated by the cultured microalgae from the microalgae using a separation membrane.

The device and method for treating nitrogen and phosphorus from wastewater provide the following advantageous effects.

Since wastewater is used as a culture medium instead of an artificial microalgal culture medium, the cost of microalgae culture medium preparation can be saved. Further, the pollutants nitrogen and phosphorus included in the wastewater can be treated as the microalgae are cultured.

Since only the treated water with decreased amount of nitrogen and phosphorus can be discharged selectively using the separation membrane, continuous culturing is possible whereby the microalgae are cultured while continuously supplying the wastewater. As a result, microalgal concentration in the culture tank can be maintained high. The continuous culturing of microalgae at high concentrations improves the removal efficiency of the pollutants nitrogen and phosphorus included in the wastewater and allows a stable treatment of the wastewater. Thus, water pollution can be minimized.

Moreover, since the microalgae which may be the source of feed and bioenergy are cultured at high concentrations, the efforts required to concentrate the recovered microalgae can be reduced.

### BRIEF DESCRIPTION OF THE DRAWINGS

The above and other aspects, features and advantages of the disclosed exemplary embodiments will be more apparent from the following detailed description taken in conjunction with the accompanying drawings in which:

FIG. 1 conceptually shows a separation membrane (immersion type) immersed in an algal culture tank according to an embodiment;

FIG. 2 conceptually shows an algal culture tank and a separation type separation membrane according to an embodiment;

FIG. 3 conceptually shows an algal culture tank and an immersion and separation type separation membrane according to an embodiment;

FIG. 4 conceptually shows an oxidation ditch type algal culture tank used as an algal culture tank according to an embodiment;

FIG. 5 shows a change of the concentration of suspended solids (SS) in an algal culture tank of a device according to an embodiment;

FIG. 6 shows a change of the concentration of chlorophyll-a in an algal culture tank of a device according to an embodiment;

FIG. 7 shows a change of the concentration of total nitrogen (TN) in an algal culture tank of a device according to an embodiment; and

FIG. 8 shows a change of the concentration of total phosphorus (TP) in an algal culture tank of a device according to an embodiment.

### DETAILED DESCRIPTION

Exemplary embodiments now will be described more fully hereinafter with reference to the accompanying drawings, in which exemplary embodiments are shown. This disclosure may, however, be embodied in many different forms and should not be construed as limited to the exemplary embodiments set forth therein. Rather, these exemplary embodiments are provided so that this disclosure will be thorough and complete, and will fully convey the scope of this disclosure to those skilled in the art. In the description, details of well-known features and techniques may be omitted to avoid unnecessarily obscuring the presented embodiments.

The terminology used herein is for the purpose of describing particular embodiments only and is not intended to be limiting of this disclosure. As used herein, the singular forms “a”, “an” and “the” are intended to include the plural forms as well, unless the context clearly indicates otherwise. Furthermore, the use of the terms a, an, etc. does not denote a limitation of quantity, but rather denotes the presence of at least one of the referenced item. The use of the terms “first”, “second”, and the like does not imply any particular order, but they are included to identify individual elements. Moreover, the use of the terms first, second, etc. does not denote any order or importance, but rather the terms first, second, etc. are used to distinguish one element from another. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

In the drawings, like reference numerals in the drawings denote like elements. The shape, size and regions, and the like, of the drawing may be exaggerated for clarity.

As used herein, “treatment” of nitrogen and phosphorus includes the removal of nitrogen and phosphorus from wastewater or reduction of the concentration of nitrogen and phosphorus of wastewater to a level commonly desired in wastewater treatment, for example, to total nitrogen 20 mg/L and total phosphorus 2 mg/L or less, which is the standard for the wastewater discharge facilities, and is not particularly limited.

In general, the speed at which microalgae treat nitrogen and phosphorus is proportional to the growth rate of the microalgae. In order to improve treatment efficiency of nitrogen and phosphorus by increasing the growth rate, it is needed to maintain the concentration of the microalgae high.

However, since the existing microalgal culture system performs culturing batch type, semi-batch type or fed-batch type culturing, whereby a mixture of microalgae cultured in the culture system and treated water is discharged to outside without solid-liquid separation and a culture medium of the same volume as the mixture of the microalgae and treated water is supplemented, the supply of the culture medium providing nutrients to the algae is carried out intermittently. Hence, the concentration of the nutrients in the culture system is not constant but changes intermittently.

The intermittent change of the concentration of the nutrients results in change of the growth rate of the microalgae. The inefficient culturing results in inefficient treatment of nitrogen and phosphorus. In the long term, continuous production of microalgae at high concentrations is difficult because of low productivity.

In addition, the existing continuous type culturing is also problematic in that solid-liquid separation of microalgae is difficult because of precipitation. As a result, it is difficult to culture the microalgae at high concentrations, thereby resulting in decreased algal productivity and low treatment efficiency of nitrogen and phosphorus.

For solving the problems raised in the existing continuous type culturing, a separation membrane is used to effectively separate the treated water with nitrogen and phosphorus removed from the cultured microalgae by solid-liquid separation in order to solve these problems. As a result, the microalgae can be continuously cultured at high concentrations. This allows to stably improve the removal efficiency of nitrogen and phosphorus from the wastewater and to improve the productivity of useful microalgal biomass.

In one embodiment, the separation membrane used for the effective solid-liquid separation of the treated water with nitrogen and phosphorus removed from the cultured microalgae may have one or more type selected from a group consisting of, for example, a hollow fiber membrane, a flat sheet membrane and a tubular membrane, although not being limited thereto.

The separation membrane, for example, may be an immersion type immersed in an algal culture tank, a separation type separated from the algal culture tank, or an immersion and separation type separation membrane.

The separation membrane, for example, may be a microfiltration membrane having a pore size of 0.1 μm to several μm, an ultrafiltration membrane having a pore size of 0.002 to 0.05 μm, or a combination thereof.

In addition, the separation membrane may be one capable of separating the microalgae from the treated water operated by a common method. For example, it may be a dead-end filtration type wherein the traveling direction of the microalgae is the same as the filtration direction of the treated water or a crossflow filtration type wherein the traveling direction of the microalgae is perpendicular to the filtration direction of the treated water, but is not limited thereto.

In one embodiment, the algal culture tank may be one or more selected from a group consisting of a rectangular complete-mix reactor (Concentration is constant in any portion of the reactor.), a rectangular plug flow reactor (The fluid travels slowly on a first in, first out basis.) and an oxidation ditch type plug flow reactor, but is not limited thereto.

The microalgae capable of treating nitrogen and phosphorus from wastewater may be, for example, one or more selected from a group consisting of Ankistrodesmus gracilis (SAG278-2: KCTC AG20745), Scenedesmus acuminatus (KCTC AG 10316), Scenedesmus quadricauda (KCTC AG 10308), Arthrospira platensis (KCTC AG20590) and Chlorella vulgaris (KCTC AG10032), but are not limited thereto.

Optionally, the device for treating nitrogen and phosphorus from wastewater may further include an additional apparatus required for continuous culturing of the microalgae at high concentrations. For example, the device may include an aerator at a lower portion of the algal culture tank for supplying air to provide CO₂ required to culture the microalgae and preventing contamination of the separation membrane, and a blower outside the algal culture tank for supplying air to the aerator.

Further, the device further may include a light source at an upper portion of the algal culture tank for providing light energy required to culture the microalgae to the algal culture tank. The light source may be an artificial light source, a natural sunlight or both.

This disclosure also relates to a method for treating nitrogen and phosphorus from wastewater, including: transferring wastewater to an algal culture tank; culturing the microalgae using nitrogen and phosphorus of the wastewater; and separating the water with nitrogen and phosphorus treated from the cultured microalgae using a separation membrane.

The separation membrane may be, for example, an immersion type immersed in an algal culture tank, a separation type separated from the algal culture tank, or an immersion and separation type separation membrane. If the separation membrane is an immersion type, the method according to this disclosure may further include, after the separation of the treated water using the separation membrane, discharging some of the microalgae and recovering them as a biomass.

Further, the separation membrane may be a separation type or an immersion and separation type separation membrane. In this case, since the separation membrane is separated from the algal culture tank, the method according to this disclosure may further include, after the separation of the treated water using the separation membrane, returning the microalgae to the algal culture tank; and discharging the microalgae from the algal culture tank and recovering them as a biomass.

The microalgae capable of treating nitrogen and phosphorus from wastewater may be, for example, one or more selected from a group consisting of Ankistrodesmus gracilis (SAG278-2: KCTC AG20745), Scenedesmus acuminatus (KCTC AG 10316), Scenedesmus quadricauda (KCTC AG 10308), Arthrospira platensis (KCTC AG20590) and Chlorella vulgaris (KCTC AG10032), but are not limited thereto.

Optionally, said culturing of the microalgae may further include using an additional apparatus required for continuous culturing of the microalgae at high concentrations. For example, an aerator may be used to supply air to provide air required to culture the microalgae. Or, a light source may be used to provide light energy required to culture the microalgae.

Hereinafter, specific, non-limiting embodiments of this disclosure will be described in detail referring to the attached drawings.

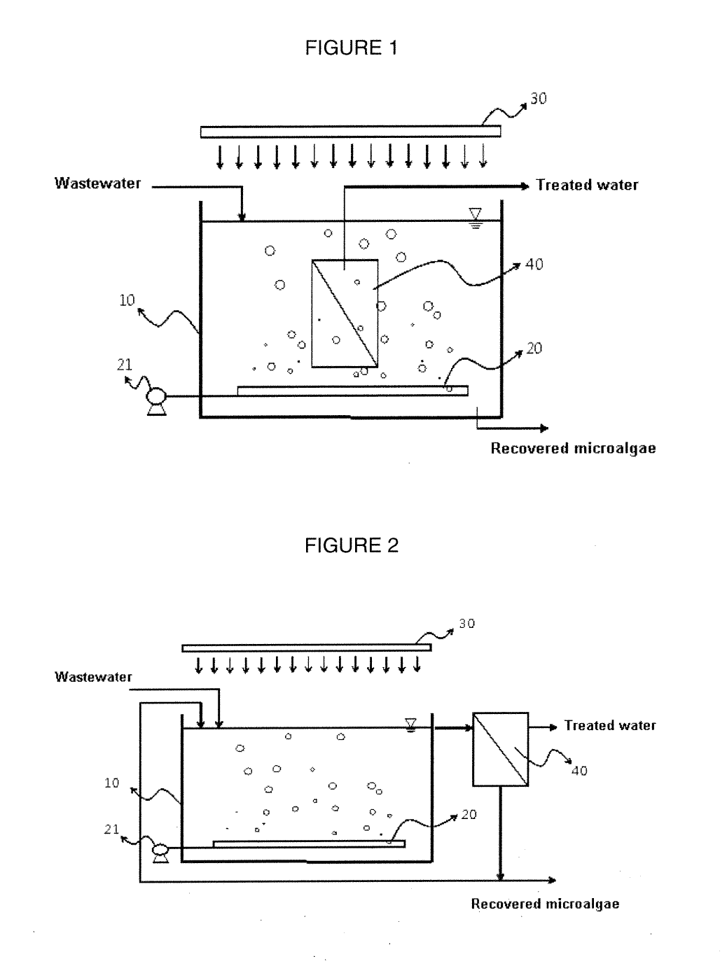

FIG. 1 schematically shows a method for treating nitrogen and phosphorus included in wastewater for culturing of microalgae at high concentrations, which comprises an algal culture tank 10, an aerator 20, a blower 21, a light source 30 and a separation membrane 40.

Referring to FIG. 1, wastewater including nitrogen and phosphorus is supplied to the algal culture tank 10 holding microalgae cultured at a constant concentration. Nitrogen and phosphorus ingredients included in the wastewater supplied to the algal culture tank 10 are used as nutrients for culturing microalgae and light energy from an artificial light source 30 or natural sunlight (not shown in the figure) is used as an energy source. Further, CO₂ included in the air supplied to the aerator 20 by the blower 21 is used as an inorganic carbon source. As a result, the quantity of the microalgae increases.

In particular, in addition to the supply of CO₂ required for the culturing of the microalgae, the aerator 20 may also serve to prevent contamination of the separation membrane 40 immersed in the algal culture tank 10. During the culturing of the microalgae, nitrogen and phosphorus included in the wastewater are treated as they are consumed, and the wastewater with nitrogen and phosphorus treated is solid-liquid separated by the separation membrane 40 immersed in the algal culture tank 10 and discharged as treated water. Some of the cultured microalgae may be discharged out of the algal culture tank 10 so that the microalgae may be cultured at a maximal rate. The discharged microalgae may be recovered as a biomass.

Unlike the existing low-concentration culture system of recovering the wastewater (culture medium) together with the microalgae without separation and supplementing the wastewater (culture medium) of the same volume, the separation membrane 40 is used to separate the microalgae from the wastewater (culture medium) and discharge only the wastewater. Through this, the concentration of the microalgae in the culture tank may be maintained high, which results in increased culturing speed and improved removal efficiency of nitrogen and phosphorus. And, since the microalgae are directly recovered from the culture tank in which the microalgae are maintained at high concentrations, the effort to increase the concentration of the microalgae in the existing low-concentration culture system to recover the microalgae can be reduced.

In particular, use of the separation membrane allows independent separation of hydraulic retention time (HRT) and solid retention time (SRT), thereby allowing a very flexible wastewater treatment. Especially, since the control of the microalgae concentration in the algal culture tank is possible, the method may be applied variously from treatment of wastewater at high concentrations such as livestock wastewater and anaerobic digestion broth to sewage.

FIG. 2 shows a separation membrane 40 separated from an algal culture tank 10 according to an embodiment. Microalgae are cultured in the algal culture tank 10 using wastewater, and a mixture of the microalgae in the algal culture tank 10 is transferred to the separation membrane 40 provided outside the algal culture tank 10, solid-liquid separated by the separation membrane 40 and discharged as treated water. The remaining concentrated microalgae are returned to the algal culture tank 10. By recovering part of the concentrated microalgae returned as concentrated water, a microalgae biomass may be obtained at high concentrations. In this case, in order to prevent contamination of the separation membrane 40, a crossflow type operation of the separation membrane 40 whereby the mixture of the microalgae and the treated water flown fast is necessary.

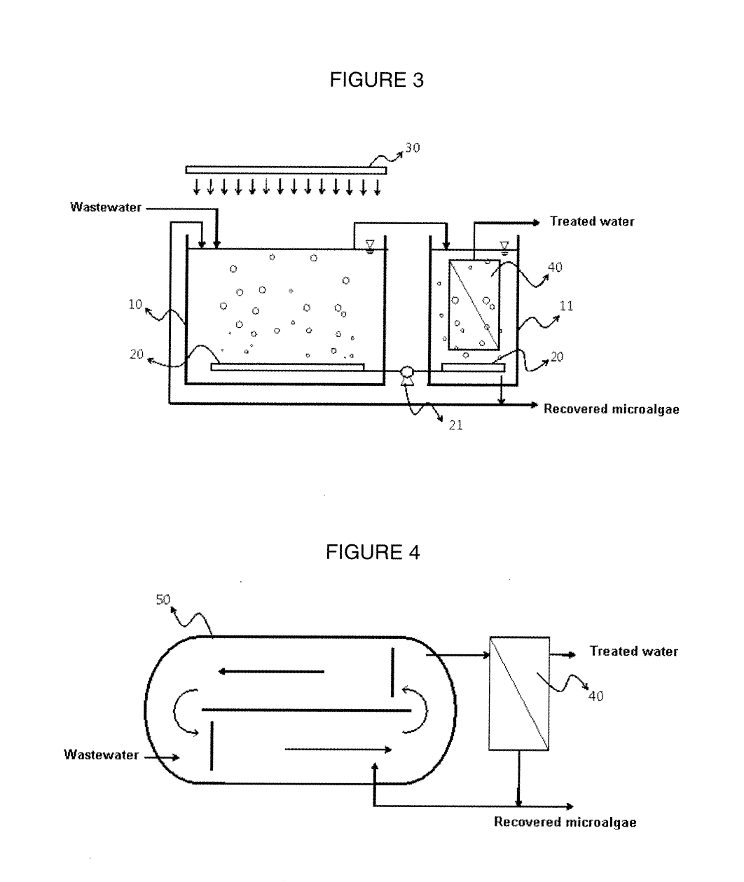

FIG. 3 shows an immersion type separation membrane 40 separated from an algal culture tank 10 according to an embodiment. A mixture of cultured microalgae in the algal culture tank 10 is continuously transferred to an immersion type separation tank 11 separated from the algal culture tank 10, solid-liquid separated at the immersion type separation tank 11 by the separation membrane 40, and discharged as treated water. The mixture of the microalgae concentrated at high concentration is returned from the immersion type separation tank 11 back to the algal culture tank 10, and some of the returned mixture is recovered as a microalgae biomass. An aerator 20 may be provided below the separation membrane 40 of the immersion type separation tank 11 of FIG. 2 or 3 in order to prevent contamination of the separation membrane 40.

FIG. 4 shows an oxidation ditch type algal culture tank 50 used as an algal culture tank according to an embodiment. As in FIGS. 2 and 3, a separation membrane may be provided separately from the oxidation ditch type algal culture tank 50 to carry out solid-liquid separation.

### EXAMPLES

The examples (and experiments) will now be described. The following examples (and experiments) are for illustrative purposes only and not intended to limit the scope of this disclosure.

### [Example] Growth of Algae Using Device for Culturing Microalgae and Change in Water Quality

Experiment was carried out as follows in order to confirm the effect of culturing microalgae at high concentrations and improving water quality of the device for treating nitrogen and phosphorus from wastewater shown in FIG. 1. Ankistrodesmus gracilis [SAG278-2: KCTC AG20745; acquired from Biological Resource Center, Korea Research Institute of Bioscience and Biotechnology (KRIBB)] and actual wastewater were used. Culturing was carried out under the condition: illumination intensity=580-600 Lx, temperature=25±5° C., air supply rate=10 L/min, HRT=12 hours, and SRT=25 days.

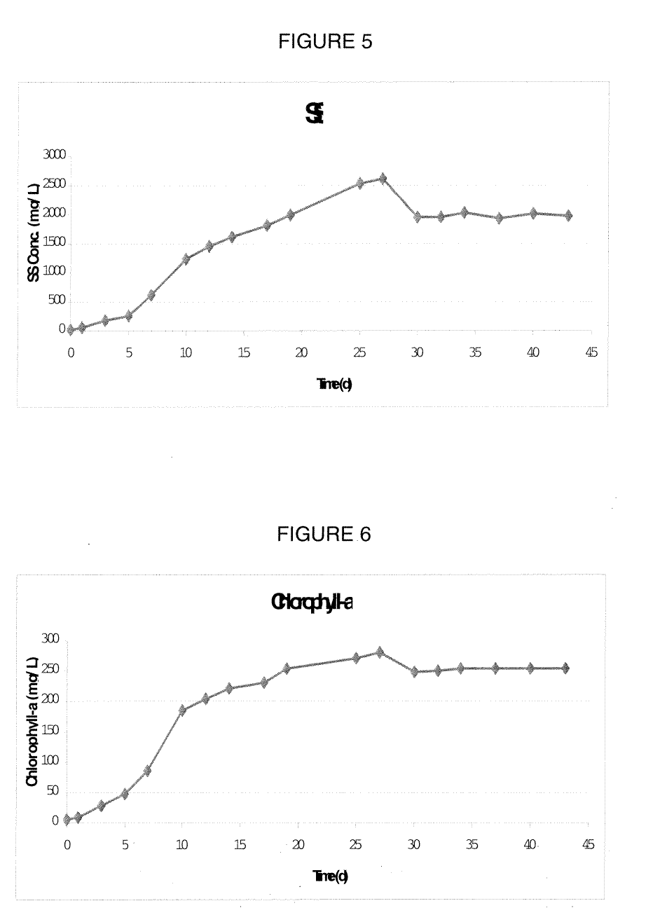

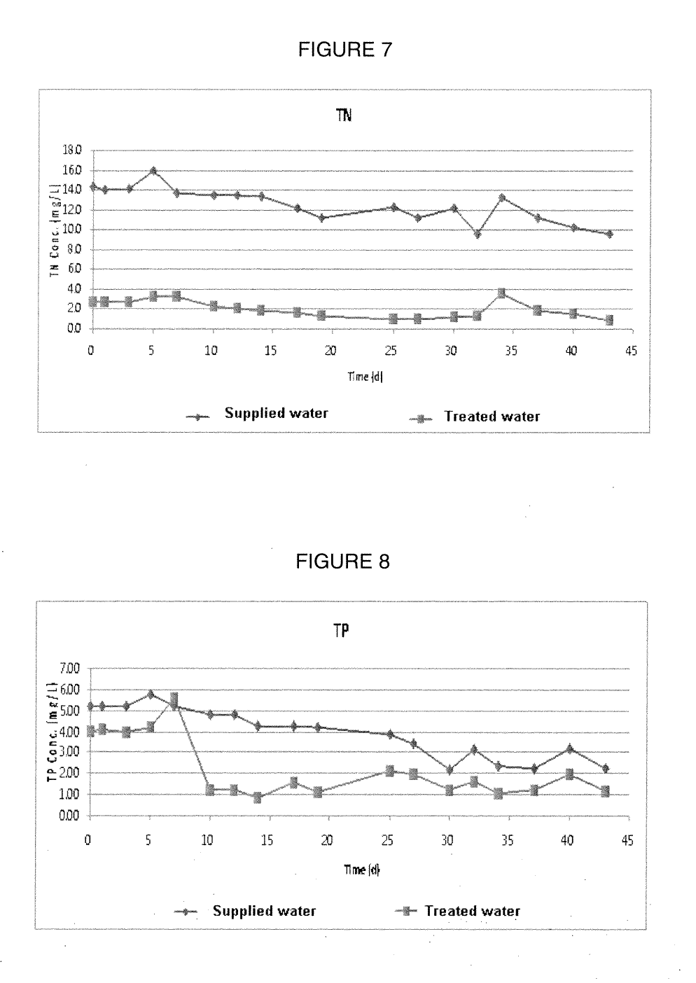

FIGS. 5 and 6 show changes of concentration of suspended solids (SS) and chlorophyll-a in the algal culture tank, and FIGS. 7 and 8 show changes of concentration of total nitrogen (TN) and total phosphorus (TP) in the wastewater coming in and out of the device.

As shown in FIGS. 5 and 6, the concentration of the microalgae could be maintained high at 2,000 mg/L or above, and 600 mg could be stably produced per day. And, as shown in FIGS. 7 and 8, total nitrogen and total phosphorus were maintained stably, which shows that nitrogen and phosphorus were removed effectively.

While the exemplary embodiments have been shown and described, it will be understood by those skilled in the art that various changes in form and details may be made thereto without departing from the spirit and scope of this disclosure as defined by the appended claims.

In addition, many modifications can be made to adapt a particular situation or material to the teachings of this disclosure without departing from the essential scope thereof. Therefore, it is intended that this disclosure not be limited to the particular exemplary embodiments disclosed as the best mode contemplated for carrying out this disclosure, but that this disclosure will include all embodiments falling within the scope of the appended claims.

What is claimed:

1. A device for treating nitrogen and phosphorus from wastewater, comprising:
an algal culture tank for culturing microalgae capable of treating nitrogen and phosphorus from wastewater; and
a separation membrane for separating thus treated water from the microalgae.

2. The device according to claim 1, wherein the separation membrane is an immersion type, a separation type or an immersion and separation type.

3. The device according to claim 1, wherein the algal culture tank is one or more selected from a group consisting of a rectangular complete-mix reactor, a rectangular plug flow reactor and an oxidation ditch type plug flow reactor.

4. The device according to claim 1, which further comprises an aerator at a lower portion of the algal culture tank.

5. The device according to claim 4, which further comprises a blower supplying air to the aerator.

6. The device according to claim 4, which further comprises a light source providing light energy to the algal culture tank.

7. The device according to claim 1, wherein the microalgae capable of treating nitrogen and phosphorus from wastewater are one or more selected from a group consisting of Ankistrodesmus gracilis (SAG278-2), Scenedesmus acuminatus, Scenedesmus quadricauda, Arthrospira platensis and Chlorella vulgaris.

8. A method for treating nitrogen and phosphorus from wastewater, comprising:
culturing microalgae capable of treating nitrogen and phosphorus from wastewater in an algal culture tank; and
separating the water with nitrogen and phosphorus treated by the cultured microalgae from the microalgae using a separation membrane.

9. The method according to claim 8, wherein the separation membrane is an immersion type separation membrane.

10. The method according to claim 9, which further comprises, after the separation of the treated water from the microalgae using the separation membrane, discharging the microalgae from the algal culture tank and recovering them as a biomass.

11. The method according to claim 8, wherein the separation membrane is a separation type or an immersion and separation type separation membrane.

12. The method according to claim 11, which further comprises, after the separation of the treated water from the microalgae using the separation membrane, returning the microalgae to the algal culture tank; and discharging the microalgae from the algal culture tank and recovering them as a biomass.

13. The method according to claim 8, wherein said culturing the microalgae further comprises supplying air required for the culturing of the microalgae using an aerator.

14. The method according to claim 13, wherein said culturing the microalgae further comprises supplying air to the aerator using a blower.

15. The method according to claim 13, wherein said culturing the microalgae further comprises providing light energy required for the culturing of the microalgae using a light source.

16. The method according to claim 8, wherein said culturing the microalgae comprises culturing one or more microalgae capable of treating nitrogen and phosphorus from wastewater selected from a group consisting of Ankistrodesmus gracilis (SAG278-2), Scenedesmus acuminatus, Scenedesmus quadricauda, Arthrospira platensis and Chlorella vulgaris.
